(19) United States
(12) Patent Application Publication
(10) Pub. No.: US 2005/0110282 A1
(43) Pub. Date: May 26, 2005

(54) Fitting

(76) Inventors: Andreas Weinberg, Stuttgart (DE); Martin Ruf, Tuebingen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/507,457

(22) PCT Filed: Mar. 11, 2003
(86) PCT No.: PCT/EP03/02449

(30) Foreign Application Priority Data
Mar. 11, 2002 (DE) 102 10 479.4

(51) Int. Cl. E05B 3/00

(52) U.S. Cl. 292/336.3

(57) ABSTRACT

The invention relates to a fitting (1), in particular for an all-glass door. Said fitting consists essentially of two fitting halves (2, 3) with a lock integrated between the latter halves, said lock comprising a bolt (4) that can be inserted and withdrawn by means of a nut (24). The fitting is characterised in that at least one door stop (26) is integrated into one of the fitting halves (2, 3).

The invention pertains to a hardware fitting, a glass door, which consists essentially of two halves.

These types of hardware fittings are used primarily for the doors of baths, showers, changing rooms, etc. These fittings have either pushbuttons or a knob. Inside the front plate of the fitting there is a means of displaying information, which tells the person approaching a door of this type whether the door is open or has already been locked from the inside. These types of “occupied” or “unoccupied” signs are designed with another button next to the pushbutton; this additional button travels outward upon rotation of the locking bolt of the lock and simultaneously rotates a disk, which conveys the information to the outside that the booth is occupied. In these types of locks, a latch is also provided in addition to the bolt; this latch is actuated by the pushbuttons, which act by way of the nut.

The task of the invention consists in expanding the state of the art by creating an aesthetically attractive hardware fitting, which serves several functions in the smallest possible space and which can also be manufactured at low cost.

This task is accomplished by the features of Claim 1. The subclaims provide further elaborations of the inventive idea.

According to the invention, a hardware fitting is proposed which consists essentially of two opposing halves, between which a lock is integrated, and which also has a stop for the door integrated into at least one of the two halves of the fitting. Each of the two halves can consist of, for example, a knob, the external form of which can be adapted aesthetically to the circumstances in question. A knob consists preferably of a round (cylindrical) component, the outward-projecting external surface of which has a certain slant. The knob that is on the outside, for example, is designed so that it has a gripping recess underneath, so that the user can pull the door more easily toward himself/herself. In addition, an emergency opening is provided inside a central bore, so that, in an emergency, a door of this type can also be opened from the outside.

The knob that is inside the closed booth also has a slanted outer surface. In contrast to the outside knob, the inside knob can be rotated, so that a locking bolt can be pushed out or pulled in by way of a nut. The locking bolt is located between the two halves of the fitting and is covered in the direction toward the edge of the door by plates on the two halves of the fitting. The locking bolt is designed as a two-stage bolt, which cooperates with a nut, which has two drivers and a stop. This stop acts on the bolt when the bolt is being pulled in. As a result of the two-stage design of the tailpiece of the bolt, the bolt is pushed out of the housing of the hardware fitting by the first driver when the knob is rotated. The second driver is designed to contact the driver of the second stage of the tailpiece and thus simultaneously has the effect of making the bolt self-locking with respect to deliberate attempts to push it back in the opposite direction.

The outer area of the inside knob is designed to consist of two different materials. One of these materials has a much lower Shore hardness than the other material. The material with the low Shore hardness, which can be a rubbery compound, for example, can be integrated into the knob either as a coating or as a separate component. For aesthetic reasons, it has been found that the projecting area of the slanted edge should extend up to about the middle of the knob. The material with the lower Shore hardness means that this half of the fitting simultaneously acts as a stop for the door against the wall located behind it.

So that the knob can be rotated more conveniently, the knob has projections on at least part of its outer circumference, which make it easy to grip and turn the knob.

The two halves of the hardware fitting are connected to each other by locating pins, which center the two halves on each other. The two halves are then tightened against each other in both a positive and nonpositive manner by a locking screw in such a way that the locking bolt is still able travel in and out easily in the middle area of the fitting.

Whereas the outside knob is connected permanently to the plate and thus to the one half of the fitting, the inside knob is designed to be installed positively on a square and locked in place from the outside by a fastening screw.

Inside the plates of the fitting, there is a display device, which tells the user both inside and outside the booth whether the door to which it is attached is locked or not. The display indicator consists of areas on the locking bolt, e.g., a green area and another, red, area for the occupied state.

The hardware fitting can be produced preferably of brass, light metal, special steel, or plastic.

A schematic diagram of a hardware fitting according to the invention is explained below on the basis of the following description of the figures:

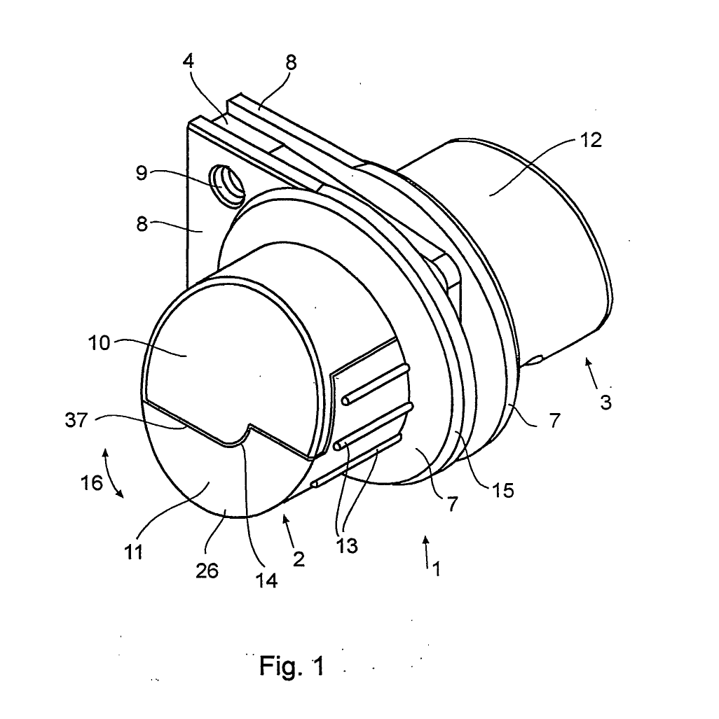

FIG. 1 shows a perspective view of a hardware fitting, where the half of the fitting which is located inside the space to be closed off is facing forward;

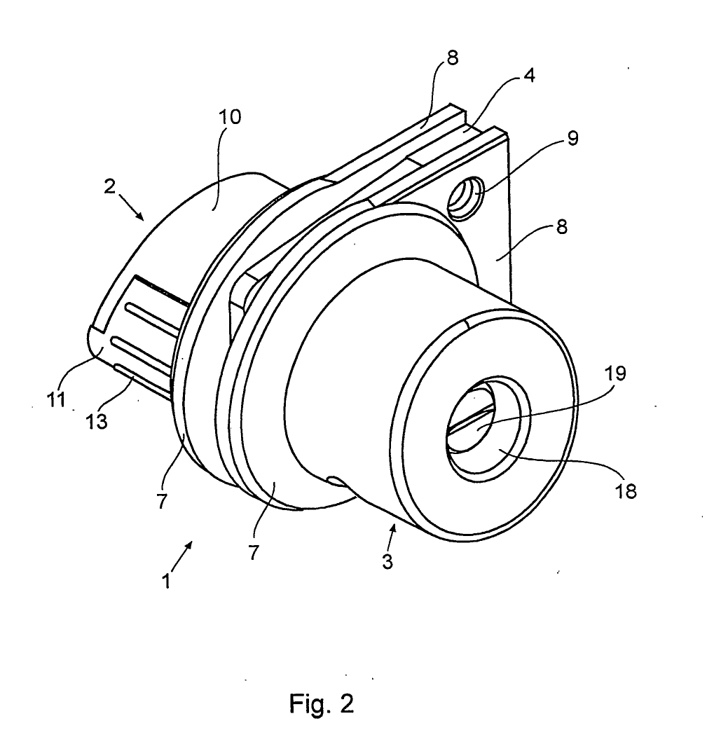

FIG. 2 shows a perspective view of a hardware fitting, where the half which faces the outside can be seen in the foreground;

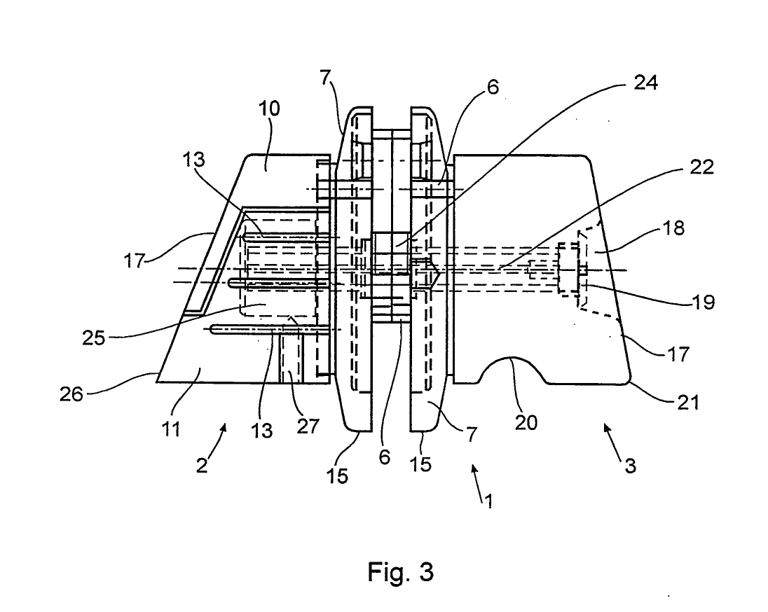

FIG. 3 shows a side view of a hardware fitting according to FIGS. 1 and 2;

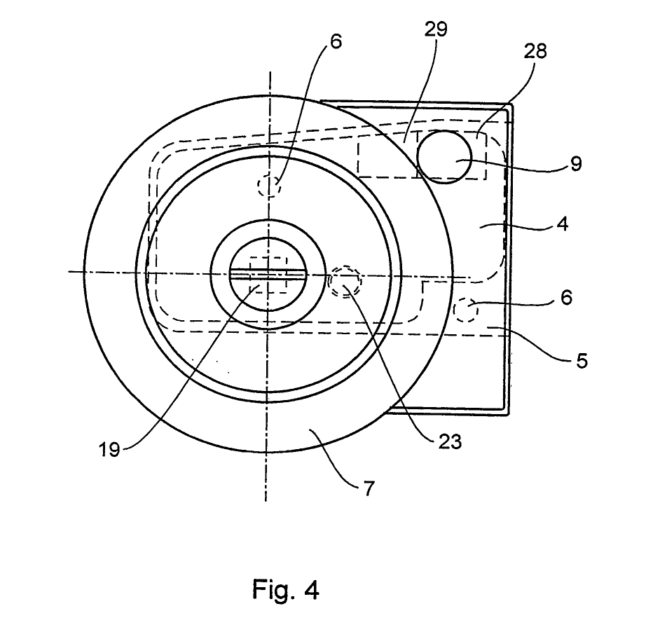

FIG. 4 shows part of the hardware fitting with its installed locking bolt, seen from the outside;

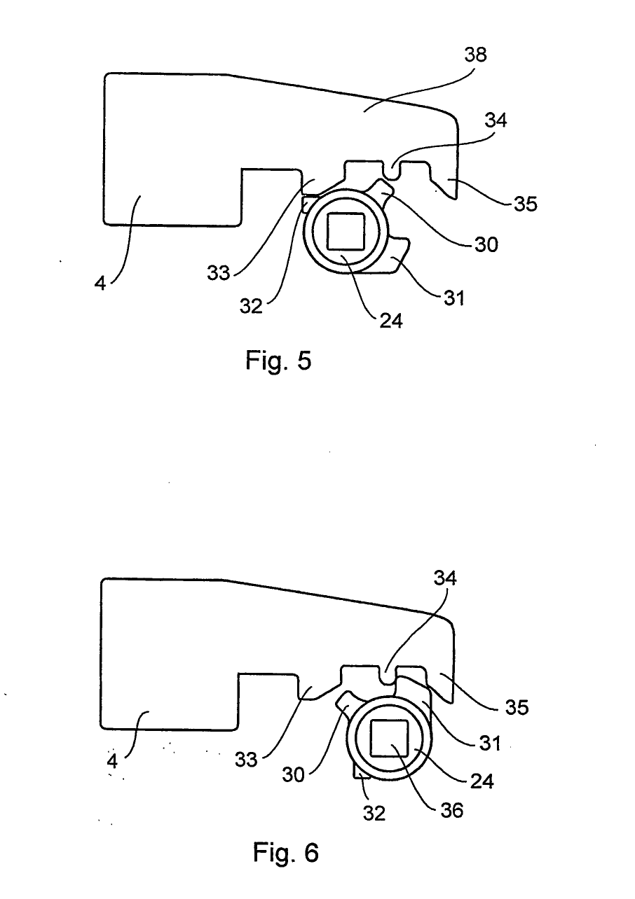

FIG. 5 shows the locking bolt in the retracted position with its nut; and

FIG. 6 shows the locking bolt in the extended position with its nut.

FIG. 1 shows a hardware fitting 1 according to the invention, which consists essentially of a fitting half 2 (attached to the inside surface of the door) and a fitting half 3 (attached to the outside surface of the door). In the exemplary embodiment of FIG. 1, the gripping elements of the two halves 2, 3 are designed as knobs.

The inside knob consists of an upper knob part 10 and a lower knob part 11. These two knob parts 10, 11 have different Shore hardnesses, the lower knob part 11 having the lower Shore hardness. The lower knob part 11 has a projecting area, which is used as a stop 26 (see FIG. 3) for the door. The outside knob 12 and the inside knob with its knob parts 10 and 11 are designed as cylindrical components. The division between the two different materials is shown by a corresponding joint line 37; the joint line 37 has an offset 14 for aesthetic reasons. On the cylindrical circumference, the material with the lower Shore hardness extends beyond the centerline of the knob and is provided with projections 13. These make it easier to grip the inside knob when it is to be turned in the directions of the arrow 16 to actuate the locking bolt. So that the knob can be rotatably designed, a recess is located inside the knob, which can be mounted positively on a driver 25, which works together with the nut. The fitting half 2 is secured by a fastening screw 27, which is screwed against the driver 25.

It is clear from FIG. 3 that the two halves 2, 3 of the fitting rest against rosettes 7, which have a bevel 15 in their fire area. FIG. 3 also shows that the outer surfaces 17 of the two halves, 2, 3 of the fitting are slanted. This is important especially for the integrated stop 26. Because of its lower Shore hardness, the stop 26 can damp the impact which occurs when the fitting half 2 meets the wall. The rosettes 7 of the two halves 2, 3 of the fitting have lateral plates 8, through each of which a hole 9 passes. The hole 9 serves as a display device to show whether the booth behind the door is occupied or not. For this purpose, markings such as colored areas can be provided on the locking bolt. When the locking bolt is extended, therefore, a “red” display field 29 is seen. When the locking bolt 4 is retracted, however, a “green” display field 28 becomes visible.

In contrast to the fitting half 2, the fitting half 3 is not connected rotatably to the other components, specifically to the nut. The fitting half 3 is designed again as a cylindrical component, which also has a slanted outer surface 17. Nevertheless, two different materials are not used. So that the fitting half 3 can be gripped more effectively, a recess 20 is provided, preferably underneath, so that the door can be pulled more conveniently.

Centered in the fitting half 3 there is a bore 18, through which a screw in the form of a connecting mandrel 22 passes. Whereas one end of the connecting mandrel 22 has a square head, which engages in the nut 24, the other end has a device 19, which makes an emergency opening possible. This can be, for example, a recess, designed in the form of a slot, so that for example, a tool can be used to open the bolted door in an emergency. A plate 8, through which a hole 9 passes, is also located on the fitting half 3 on this side; the plate can thus function again as a display device in conjunction with the display fields 28, 29 on the locking bolt 4.

The way in which the locking bolt 4 is installed in the hardware fitting 1 can be seen in FIG. 4. The figure also shows that the locating pins 6 extend from the one half 2, for example, and engage in the other half 3. The locating pins 6 are driven permanently into one or the other of the two halves 2, 3 and can be inserted loosely in the other half. As a result, the two halves of the fitting are centered and aligned inside a cutout in the glass (i.e., in the door, not shown). The two halves 2, 3 are connected by a locking screw 23, which is preferably not on the axis of the nut 24.

The schematic diagrams of FIGS. 5 and 6 show the locking bolt 4 with the nut 24. Whereas the locking bolt 4 has traveled into the hardware fitting 1 in the diagram according to FIG. 4, FIG. 6 shows the locking bolt 4 after it has traveled out of the fitting.

On the locking bolt 4 there is a tailpiece 38, on which a driver 33 and a driver 34 are formed. In addition, a stop 35 is also present on the tailpiece 34. In the “open position” of FIG. 5, a stop 32, which is present on the nut 24, rests against the driver 33. This prevents the locking bolt 4 from moving any further inward. When the nut 24 is now turned to the left in FIG. 5, the driver 30 of the nut 24 engages in the first stage; that is, it contacts the driver 33 of the tailpiece 38 and thus moves the locking bolt 4 out of the fitting 1 and into its locking position. After the driver 30 is no longer in contact with the driver 33, the driver 31 of the nut comes to rest against the driver 34 of the tailpiece 38. Because the driver 33 has a rounded external contour and is wider than the driver 30, the driver 31 also comes to rest against a stop 35 of the tailpiece 38. Thus it is no longer possible for the locking bolt 4 to any farther outward. At the same, time, however, this position of the nut 24 ensures a locking of the locking bar 4 against unintentional travel in the reverse direction.

List of Reference Numbers
1 hardware fitting
2 (inside) half of the fitting
3 (outside) half of the fitting
4 locking bolt
5 cutout in the glass
6 locating pin
7 rosette
8 plate
9 hole
10 upper (inside) knob part
11 lower (inside) knob part
12 outside knob
13 projections
14 offset
15 bevel
16 directions of rotation
17 outer surface
18 bore
19 emergency opening
20 recess
21 rounded edge
22 connecting mandrel
23 locking screw
24 nut
25 driver
26 stop
27 fastening screw
28 display field (green)
29 display field (red)
30 driver
31 driver
32 limiting stop
33 first driver
34 second driver
35 stop
36 square
37 separation line
38 tailpiece of the locking bolt

1-21. (canceled)

22. A hardware fitting for an all-glass door, comprising:
a first fitting half arrangeable on an outer side of the door and a second fitting half arrangeable on an inner side of the door;
an actuatable nut arranged between said first and second opposing halves;
a lock having a locking bolt arranged between said first and second opposing halves, said locking bolt being slidable between a retracted and an extended position in response to a movement of said nut; and
a door stop integrated into at least one of the first and second halves.

23. The hardware fitting of claim 22, wherein each of said first and second fitting halves are designed as knobs, each of said knobs having end surface facing away from the other of said knobs, said end surfaces being slanted such that the end surfaces are not perpendicular to a longitudinal axis of said knobs, wherein said at least one of said first and second opposing halves comprising the integrated door stop comprises two different parts made of different materials, one of said materials having a lower Shore hardness than the other of said materials.

24. The hardware fitting of claim 22, each of said first and second fitting halves has a plate facing the other of said first and second fitting halves and extending laterally on at least one side of said each of said first and second fitting halves.

25. The hardware fitting of claim 22, wherein the hardware fitting is arrangeable on doors of baths, showers, and changing rooms.

26. The hardware fitting of claim 24, further comprising a display device arranged in said plates and indicating a state of occupancy relative to a position of said locking bolt.

27. The hardware fitting of claim 26, wherein said display selectively displays an “unoccupied” state and an “occupied” state in the form of color-coded display fields.

28. The hardware fitting of claim 22, wherein one of said first and second fitting halves is connected in a fixed in position and the other of said first and second halves is rotatable, and wherein said rotatable one of said first and second fitting halves is connected to said nut for actuating said locking bolt.

29. The hardware fitting of claim 22, wherein one of said first and second fitting halves has at least one recess in its outer contour.

30. The hardware fitting of claim 22, wherein said one of said first and second fitting halves has a central bore leading to said nut, said hardware fitting further comprising a connecting mandrel which passes through said central bore and acts on said nut.

31. The hardware fitting of claim 30, further comprising an emergency opening device connected by the connecting mandrel to said nut, wherein said emergency opening device is actuatable for retracting said locking bolt.

32. The hardware fitting of claim 28, further comprising a driver connected to said nut and receiving said second fitting half, and a locking screw for fixing said second fitting half to said driver.

33. The hardware fitting of claim 22, wherein said second fitting half comprises an upper knob part and a lower knob part, said lower knob part one of is made of a material having a lower Shore hardness or is coated with the material having a lower Shore hardness than said upper knob part.

34. The hardware fitting of claim 33, wherein said material having a lower Shore hardness comprises one of rubber and a material exhibiting characteristics of rubber.

35. The hardware fitting of claim 33, wherein said lower knob part extends approximately as far as a center of an outside surface of said second fitting half.

36. The hardware fitting of claim 33, wherein said upper and lower knob parts of said second fitting half are round.

37. The hardware fitting of claim 33, wherein said lower knob part comprises radial projections.

38. The hardware fitting of claim 22, wherein said first and second fitting halves are centered relative to each other by locating pins and connected to each other by a locking screw.

39. The hardware fitting of claim 22, wherein said nut comprises two drivers and a limiting stop for actuating said locking bolt in two stages.

40. The hardware fitting of claim 39, wherein said locking bolt is self-locking in the extended position.

41. The hardware fitting of claim 27, wherein said display fields are provided on said locking bolt.

42. The hardware fitting of claim 22, wherein said first and second fitting halves are made of one of brass, light metal, special steel, and plastic.
